(19) United States
(12) Patent Application Publication
(10) Pub. No.: US 2002/0146120 A1
(43) Pub. Date: Oct. 10, 2002

(54) Inspecting print quality using digital watermarks

(76) Inventor: Hugh Anglin, Claremore, OK (US)

Correspondence Address: ELMER GALBI, 13314 VERMEER DRIVE, LAKE OSWEGO, OR, 97035

(21) Appl. No.: 09/826,616

(22) Filed: Apr. 5, 2001

(51) Int. Cl. G09C 5/00

(52) U.S. Cl. 380/54

(57) ABSTRACT

An automatic label inspection system that is relatively inexpensive, flexible and easy to set up. A digital watermark is embedded in a label prior to the printing process. As is conventional in digital watermark technology, the digital watermark is duplicated many times in multiple areas of the image. That is, the images is divided into area and a copy of the watermark is embedded into each area. Conventional digital watermarks often include both a grid and a payload signal. The present invention merely requires use of the watermark grid signal. A label is inspected by reading the watermark grid signal from each area of the image. The strength of the watermark grid signal is used as a measure of the quality of the label.

### FIELD OF THE INVENTION

The present invention relates to label printing and more particularly to inspecting printed labels.

### BACKGROUND OF THE INVENTION

In many manufacturing operations, labels are applied to products or packages at very high speed. It is very important for a variety of reasons that the labels be printed correctly and that they be applied correctly. Among the reasons are the fact that the labels create a product image and the fact that some labels contain notices that are required for legal reasons.

Automatic label inspection using machine vision is possible. However, labels often use colors and materials which make it difficult if not impossible to effectively inspect labels using relatively simple binary or gray scale inspection technologies. Presently in some situations, colored labels are automatically inspected using a “golden template”. With such systems an image of the label acquired by a machine vision system. The acquired image is then automatically compared to the golden template. Various known computerized image correlation techniques can determine if the quality of the acquired image matches established the “golden template”.

In general, prior art automatic label inspection systems are expensive and difficult to maintain. Furthermore existing automatic label inspection systems often involve time consuming set up processes for each new label. Often the set up process requires a high degree of technical expertise.

The present invention is direct to providing an providing an improved lable inspection system.

### SUMMARY OF THE PRESENT INVENTION

The present invention provides an automatic label inspection system that is relatively inexpensive, flexible and easy to set up. The system and method of the present invention utilizes digital watermarks. With the present invention a digital watermark is embedded in a label. As is conventional in watermark technologyh, the digital watermark is duplicated many times in the image. That is, the image printed on the label is divided into areas and a copy of the watermark is embedded into each area. Conventional digital watermarks often include both a grid and a payload signal. The present invention merely requires use of the watermark grid signal. A label is inspected by reading the watermark grid signal from each area of the image. The strength of the watermark grid signal in each area is used as a measure of the quality of the printing on the label in that area.

### BRIEF DESCRIPTION OF THE DRAWINGS

FIG. 1 illustrates a label divided into areas.

FIG. 2 is a block diagram of a system used to practice the invention.

FIG. 3 and 4 illustrate examples of where the grid signal was detected in the image of two different labels.

FIG. 5 is a block flow diagram of the operation of the invention.

### DETAILED DESCRIPTION

The present invention utilizes existing digital watermark detection and reading technology such as that described in U.S. Pat. Nos. 5,636,292, 5,710,834, 5,721,788, 5,748,783, 5,768,426, 5,841,978 or 6,122,403 all of which are hereby incorporated herein by reference. With the present invention, digital watermarking technology is applied to automatically inspect and determine the quality of printing on a label.

The term label as used herein means any printed image or text that appears on a package or item. The printed image can include text and graphic material or pictures. A label can be a relatively small such as the type of label that provides a notice required by the FDA on a medicine bottles A label may be relatively large such as the label that would appear on the side of a box containing a refrigerator. A label may be glued to an item or it can be text and graphic material printed on a box such as the text and images that appear on many cereal boxes. A label consists of an image printed on a carrier. The carrier can be paper, cardboard or plastic.

Labels are used to provide information and/or an appealing image to consumers. In may cases labels carry important information. During manufacturing operations, there is a need and desire to quickly and effectively check the quality of the printing on a label and to insure that a label has in fact been correctly placed on an item.

Known watermark technology such as that described in the above referenced patents, utilizes a watermark that has both a grid and a payload or data signal. The present invention merely requires the use of a digital watermark that includes a grid signal. However, a digital watermark that includes both a grid and a payload signal can also be utilized to carry other useful information as described later with respect to alternate embodiments of the invention.

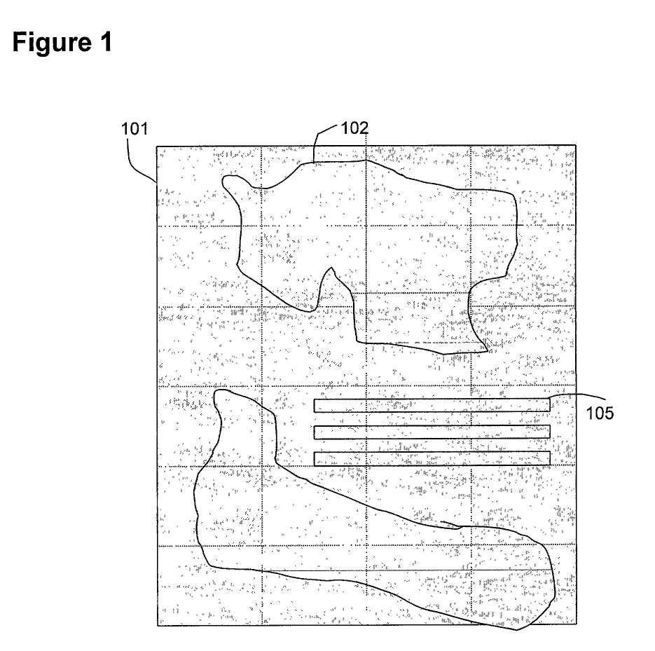

FIG. 1 illustrates a printed label. A watermark is redundantly embedded into the image. It is noted that the label has some background coloring into which a watermark can be embedded. The label shown in FIG. 1 may be a gray scale or a multicolor image. The technology for embedding watermark into such images is well known. The shapes such as 102 merely indicate that the label includes the type of graphic that is conventionally on labels. The lines 105 indicate that the label includes textual material.

The doted lines in FIG. 1 which divide the image into a number of square areas illustrate the fact that the image is divided into areas and the watermark is redundantly embedded into each of the areas in the image. The typical image would be divided in areas, the size of which, would be in the order of one hundred or two hundred pixels square. The lines in FIG. 1 merely illustrate that there are multiple areas into which the watermark in embedded.

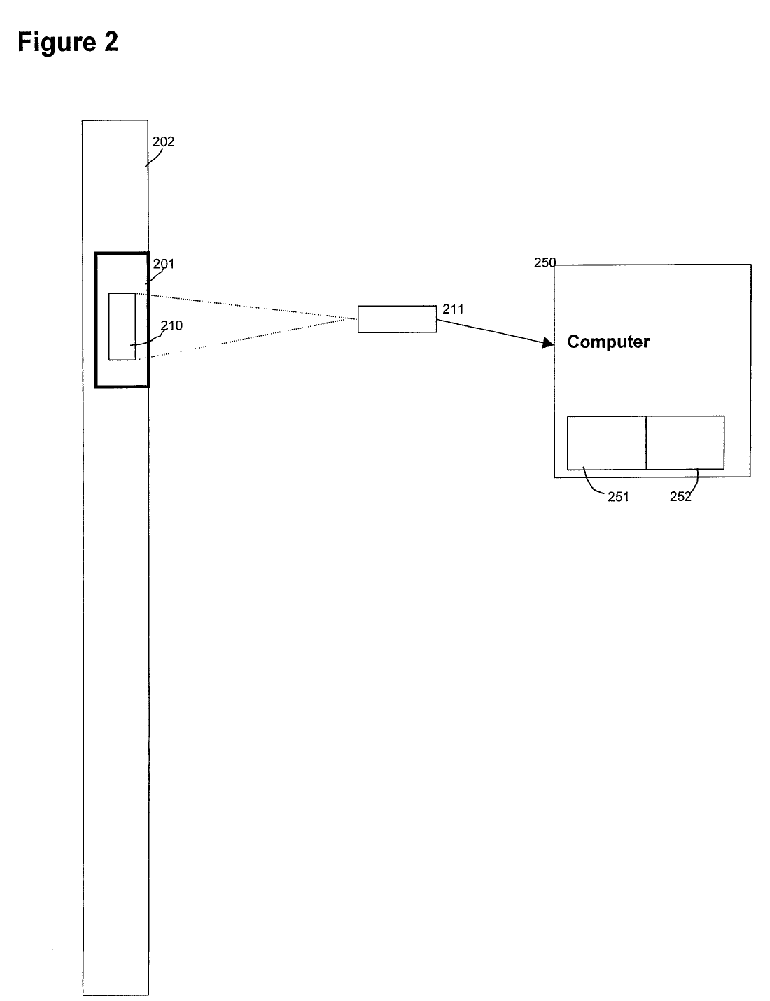

FIG. 2 illustrates a system for practicing the present invention. A package 201 moves along a conveyor 202. The package 201 includes a label 210. A camera 211 captures an image of the label 210 and sends the image to a computer 250. The computer 250 includes a conventional operating system (such as for example the Microsoft Widows operating system) and a watermark reading program 251. The output of the watermark reading program 251 goes to a comparison program 252 which compares the grid signal in each area to acceptable limits. The camera 211 can be a conventional digital camera. It is noted that in alternative embodiments, instead of using a computer with an operating system such as Microsoft Windows, the computer 250 is what is termed an “embedded system” program to perform the required tasks and camera 211 can be an analog camera with a suitable capture card.

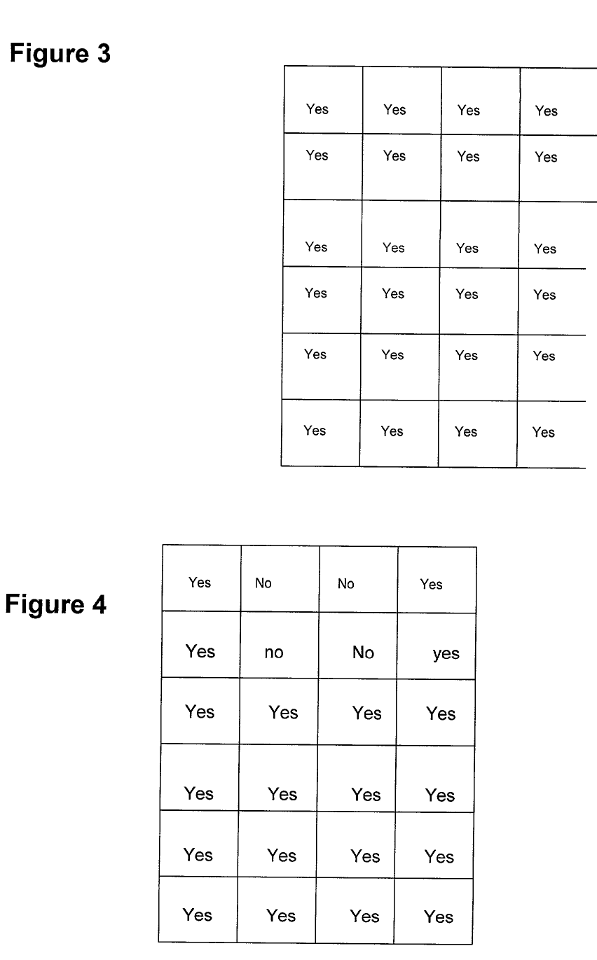

Examples of the result are shown in FIGS. 3 and 4. In the example given in FIG. 3, the grid signal is detected in each tile in which the watermark is embedded. Hence, the detected results indicate that the label was printed correctly. In the example given in FIG. 4, in four of the tiles, no grid signal was detected. Hence, the results indicate that this label was not printed correctly.

In alternative embodiments, algorithms which determine pass/fail criteria based on neighborhood operations are used. For example, a week grid signal in one tile might be acceptable if there were a strong signal in all surrounding (neighboring) tiles. In other alternative embodiments, morphological algorithms are employed to perform erosions, dilations, openings and closings, etc. Furthermore, blob labeling with ensuing feature extraction could be used to find moment data for qualifying defects.

If a label does not meet the required criteria it is deemed unacceptable. In such a case the package with the unacceptable label is either appropriately marked for re-labeling or the package is removed from the conveyor for further processing which can for example include re-labeling the package.

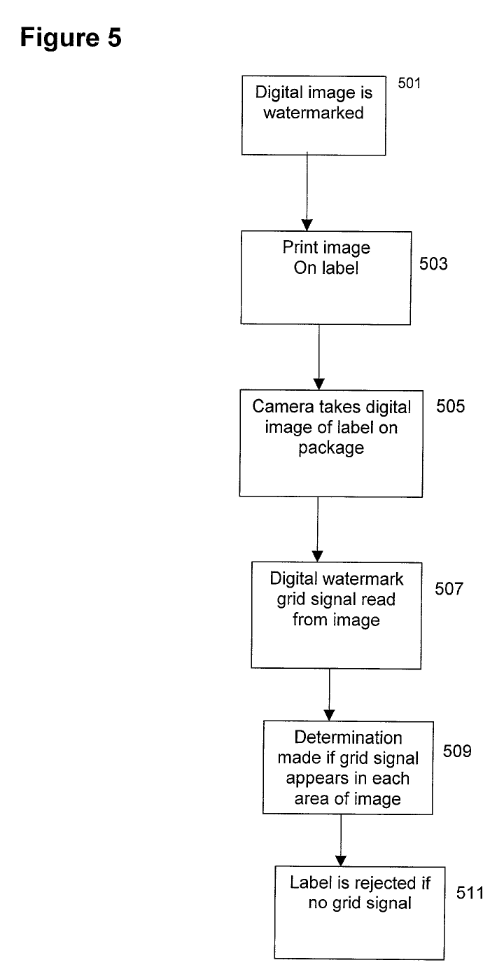

The flow diagram in FIG. 5 illustrates how the invention operates. The process begins with an image of a label. The image is in digital form. The initial image can either be designed in digital form (as is often done) or a physical label can be scanned to create a digital image. As indicated by block 501, the image of the label is watermarked. This can be done with a conventional watermarking program. During the watermarking operation a grid signal is embedded in each area of the image. That is, the grid signal is redundantly embedded in multiple areas of the image. This grid signal is embedded in the image by modifying the pixels of the image to embed specific spatial frequencies in the image. The changes done to embed these spatial frequencies are such that they can not be recognized by a human observer; however, they can be detected by a watermark reading program. Embedding selected special frequencies in an image can be done with conventional watermarking technology.

As indicated by block 503, the digital image is printed onto a carrier ( i.e. on a physical label) and the physical label is applied to a package. The image can be printed on the carrier (i.e. on the physical label) and the physical label can be applied to the product in the conventional manner.

Next as indicated by block 505 the labels are passed by a digital cameras and an image of the label is acquired. The watermark is next read from the acquired image as indicated by block 507. Reading the watermark involves determining what spatial frequencies appear in each area of the watermark. This operation is done in a conventional manner. Next as indicated by block 509, a determination is made as to whether the spatial frequencies that represent a grid signal are present in each area of the image. That is a determination is made as to which areas of the acquired image include the grid signal. The result of this operation is data such as that shown in FIGS. 3 and 4, the image. This can be a simple “yes” no type of operation, or it can take into account the magnitude of the various frequencies. In any event the frequency spectrum of image the signal is examined to determine if there is a watermark grid signal in each area of the image.

If there is no grid signal in an area where there should be a grid signal, the label is rejected. Alternatively, if the magnitude of the grid signal in a particular are is below a preset threshold the label is rejected.

Naturally on some labels area of the label are blank, hence, one would not expect to find a signal in these areas and these selected area are ignored. With many existing watermark reading program the first step performed by the program is to determine if the image has been enlarged or rotated. With this application of digital watermark technology, those steps are not necessary, since the size of the acquired image is fixed and the location of the tiles where the watermark is embedded is known. However, if the speed of the convey is such that synchronization is not easily possible, the conventional steps used to locate area where a watermark is located could be used.

It is noted that the present invention also can be used to detect if a label is in fact present on a package. If for example, a label is misplaced, or if a label is not present on a package, the watermark reading program would not detect a grid signal.

While the embodiments of the invention described above utilize a conventional watermark grid signal, specialized watermark signals could be developed which in some situations would provide a better quality measurement for labels. Furthermore, in alternative embodiments of the invention, in addition to containing a grid signal, the watermark could contain other data. For example, the watermark could include data which allows someone to link to a web site using the technology described in PCT publication WO 00/70585 published Nov. 23, 2000 and entitled “Methods and Systems for Controlling Computers or Linking to the Internet Resources from Physical and Electronic Objects”. His publication is hereby incorporated herein by reference. Thus the label inspection process according to the present invention could utilize a digital watermark that is placed on the label for other purposes such as for allowing a consumer to link to a web site. While the invention has been described with respect to preferred embodiments of the invention, it should be understood that various changes in form and detail may be made without departing from the spirit and scope of the invention. Applicant's invention is limited only by the appended claims.

I claim:

1. A method of determining if a printing process operated correctly comprising the steps of:
digitally watermarking an image, said watermark being redundantly applied in multiple areas of said image,
printing said image on a carrier,
acquiring a second image of the image printed on said carrier,
reading the digital watermark data from each area of said second image,
determining the quality of the printing from the acquired digital watermark data.

2. The method recited in claim 1 wherein said watermark includes a grid signal.

3. The method recited in claim 1 wherein said carrier is a label.

4. The method recited in claim 1 wherein said second image is acquired using a digital camera.

5. The method recited in claim 3 wherein said label is rejected if said digital watermark data does not meet certain criteria.

6. The method recited in claim 1 wherein quality is deemed unacceptable if digital watermark data can not be read from each area of said second image.

7. The method recited in claim 2 wherein said quality is deemed unacceptable if said grid signal can not be read from each area of said image.

8. A method of determining the quality of a printed image comprising the steps of:
digitally modifying said first image to embed a digital watermark in said image,
printing said first image onto a carrier to create a printed image,
acquiring a second image of said printed image,
reading said watermark from said second image to generate watermark data, and
determining the quality of said printing from said watermark data.

9. The method recited in claim 8 wherein said carrier is a label.

10. The method recited in claim 8 wherein said watermark comprises a grid signal.

11. The method recited in claim 8 wherein said watermark includes a grid signal.

12. The method recited in claim 8 wherein said watermark is redundantly embedded in multiple areas of said image.

13. The method recited in claim 12 wherein said carrier is a label.

14. The method recited in claim 13 wherein said label is rejected if said watermark can not be read from at least one area of said label.

15. A system for determining the quality of a printed image, said printed image including a digital watermark, said watermark being redundantly applied to multiple areas of said printed image, said system comprising,
an image capture device for acquiring a second image of said printed image,
a watermark reading program for reading watermark information from each of said areas of said image,
examining the magnitude of watermark information to determine the quality of said printing.

16. The system recited in claim 16 wherein said digital watermark includes a grid signal.

17. A system for determining if the quality of printed labels is acceptable, said labels being printed with an image which includes a digital watermark embedded in multiple areas of said image,
means for acquiring an image of said labels after said labels have been printed,
means for reading watermark data from each area of said image of said labels,
means for indicating that the quality of said labels is unacceptable if the watermark data read from each area of said image does not meet specified criteria.

18. The system recited in claim 17 wherein said digital watermark includes a grid signal.
